(19) United States
(12) Patent Application Publication
(10) Pub. No.: US 2014/0232851 A1
(43) Pub. Date: Aug. 21, 2014

(54) M-ATV Driver's Vision Augmentation System

(71) Applicant: United States of America, as represented by the Secretary of the Army, (US)

(72) Inventors: Arthur A. Hough, Mechanicsville, VA (US); Philip S. Zinser, Spotsylvania, VA (US); Thomas J. Soyka, Alexandria, VA (US); Benjamin J. Jeffers, Arlington, VA (US); Yau L. Fung, Fairfax, VA (US)

(73) Assignee: United States of America, as represented by the Secretary of the Army, Fort Belvoir, VA (US)

(21) Appl. No.: 13/771,299

(22) Filed: Feb. 20, 2013

(51) Int. Cl. H04N 7/18

(52) U.S. Cl. CPC H04N 7/181
USPC 348/118

(57) ABSTRACT

Video aids are disclosed to assist vehicle drivers for all phases of vehicle control and driving conditions. In one exemplary embodiment, a driver's vision augmentation system is flexibly configured for installation on virtually any vehicle for real-time video display to the vehicle driver of each tire's contact with the ground. Such a driver's vision augmentation system can improve one's ability to drive in off-road conditions, e.g., through an otherwise impassable terrain, in order to increase survivability and improve chances for mission success.

### GOVERNMENT INTEREST

The invention described herein may be manufactured, used, sold, imported, and/or licensed by or for the Government of the United States of America.

### FIELD OF THE INVENTION

This invention relates in general to vehicular vision augmentation systems, and more particularly, to video aids to assist vehicle drivers for control under various driving conditions.

### BACKGROUND OF THE INVENTION

Mine Resistant Ambush Protected (MRAP) -all terrain vehicles may be hampered by limited visibility, affecting their off-road mobility and safe driving. Limited visibility may limit the driver's view of the immediate area(s) around the vehicle, particularly when driving in off-road conditions.

Specifically, when operating an MRAP all-terrain vehicle, the driver may not be able to see the immediate area(s) around the vehicle when driving in off-road conditions. Further, there may be blind spots and other hazards associated with such a limited driving visibility.

### SUMMARY OF THE INVENTION

A driver's vision augmentation system can be configured to enhance an all terrain vehicle to allow its driver to see the immediate area(s), e.g., around each tire, in order to enhance the vehicle in off-road mobility and/or reduce the number of vehicle accidents. Such a system may also provide up to 360 degree situation awareness.

Video aids are disclosed to assist vehicle drivers for vehicle control under all types of driving conditions. For example, a driver's vision augmentation system (M-DVAS) can be flexibly configured for installation on virtually any vehicle, e.g., an MRAP-all terrain vehicle (M-ATV), for real-time video display to the vehicle driver of immediate area(s), e.g., display(s) of each tire's contact with the ground.

In one exemplary embodiment, a vision augmentation system for installation on a vehicle provides video aids to assist vehicle drivers, comprising a plurality of cameras providing video inputs; a quad video processor powered by a power source, wherein the quad video processor receives the video inputs from the cameras and outputs an appropriate video display; and a touch screen display to receive the output from the quad video processor and display said appropriate video display, the touch screen display being separately connected to a converter unit for touch screen connection back to the quad video processor for touch-screen control of said appropriate video display.

Yet, in another exemplary embodiment, a vision augmentation method for providing video aids to assist a vehicle driver comprises choosing video cameras for operation in a select portion of the electromagnetic spectrum; configuring said video cameras around an exterior of a vehicle to provide video inputs of respective real-time imagery, including video inputs of ground tire contacts; providing a touch screen display capable of displaying said real time imagery in a quadrant display layout; providing a control unit powered by a power source, wherein a programmable video quad unit inside the control unit receives the video inputs from the cameras and sends the appropriate video display to the touch screen display; and providing a control capability to switch between a full screen view of any selected camera input and a quad screen display with the use of the touch screen display.

Enhancing the driver's ability to negotiate an off-road terrain can increase the vehicular survivability and increase the chance of mission success by successfully negotiating a terrain otherwise deemed impassable. Accordingly, such an M-DVAS system can improve a soldier's ability to more safely drive in off-road conditions, e.g., through an otherwise impassable terrain, in order to increase survivability and improve chances for mission success.

### BRIEF DESCRIPTION OF THE DRAWINGS

Additional advantages and features will become apparent as the subject invention becomes better understood by reference to the following detailed description when considered in conjunction with the accompanying drawings wherein:

FIG. 1 shows a block diagram of an exemplary driver's vision augmentation system (M-DVAS);

FIG. 2 shows an exemplary M-DVAS camera placement around the periphery of an all terrain vehicle;

FIG. 3 shows an exemplary M-DVAS touch screen display layout; and

FIG. 4 shows an exemplary M-DVAS driver display.

### DETAILED DESCRIPTION

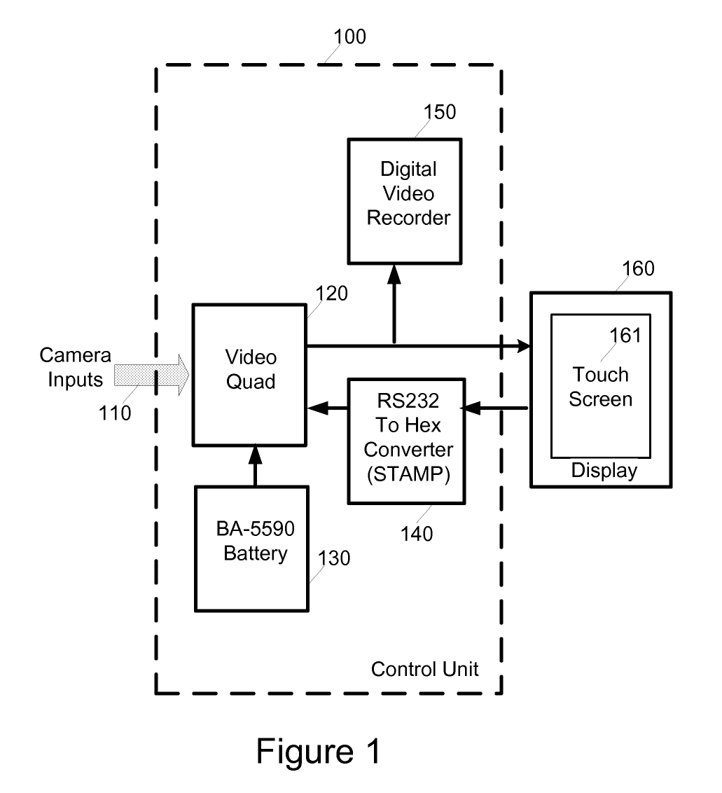

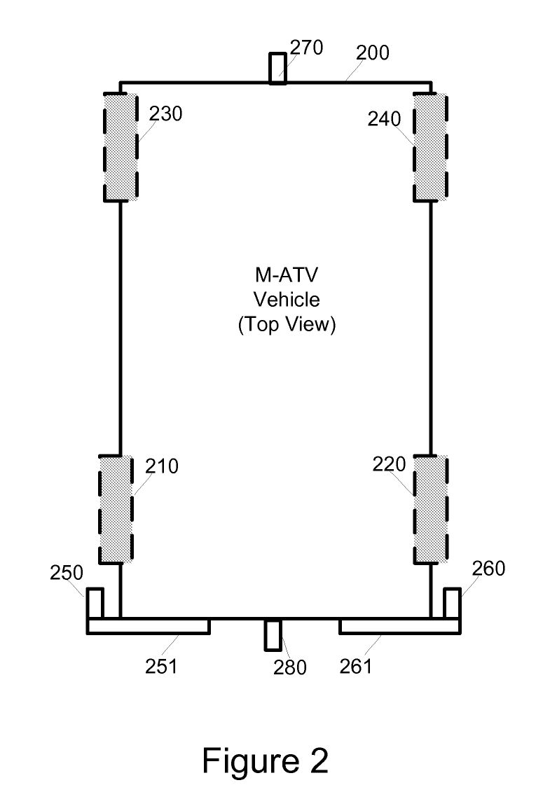

The disclosure relates to a driver's vision augmentation system, e.g., as exemplified as a control unit 100 based system in FIG. 1, to assist vehicle drivers during all phases of vehicle control and driving conditions. Shown in FIG. 1 is such an exemplary driver's vision augmentation system with camera input(s) 110 to a quad video processor 120 powered from a power source, e.g., by a BA-5590 battery 130. Alternatively, power can be externally provided, e.g., from the vehicle. The quad video processor 120 is shown connected to a digital video recorder 150 and a touch screen display 160. The touch screen display is separately connected to a RS 232-to-hex converter unit 140 designated as STAMP, which unit 140 is connected back to the quad video processor 120. Due to its flexibility, the variously described exemplary embodiments as shown in FIG. 1 can be installed on virtually any vehicle to provide video aids to assist vehicle drivers as shown in FIG. 2.

An exemplary Mine Resistant Ambush Protected (MRAP) vehicle 200 is shown in FIG. 2 configured with cameras (250, 260, 270, 280) associated with such a driver's vision augmentation system (M-DVAS) to allow its driver to see the immediate area(s), e.g., around each tire (210, 220, 230, 240). A driver's vision augmentation system can be configured with such an MRAP vehicle to allow its driver to see the immediate area(s) around each tire in order to enhance the vehicle in off-road mobility and reduce the number of vehicle accidents. Such a system may also provide up to 360 degree situation awareness.

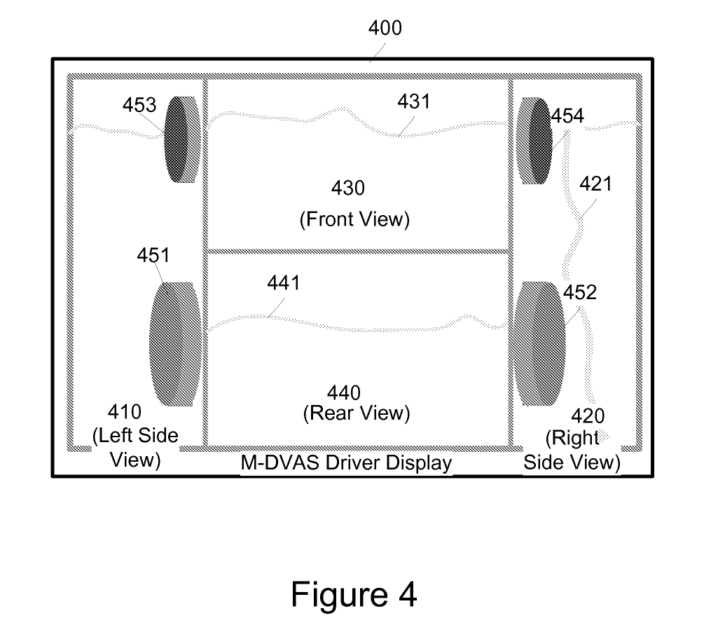

An exemplary M-DVAS (e.g., as shown in FIG. 1) is a ruggedized camera system capable of being self-powered (e.g., 130), with touch screen display 160 and compact flash-based digital video recording system 150 configured to provide M-ATV drivers with video aids showing the exact vehicle wheel placement(s), e.g., while driving in off-road or otherwise hazardous terrain conditions. See, e.g., FIG. 4.

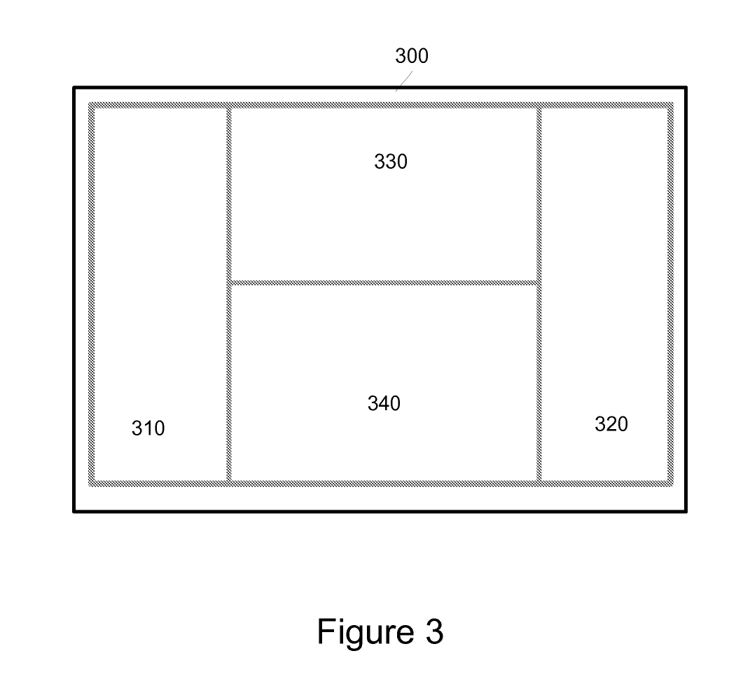

As exemplified in FIG. 2, an exemplary M-DVAS is shown with four video cameras (250, 260, 270, 280) deployed around the vehicle 200. The control unit (CU) 100 and a touch-screen monitor 160 are separately shown in FIG. 1. Two cameras (250, 260) are shown mounted on the respective bracket (251 or 261) behind the respective rear wheel (210 or 220) looking forward. This configuration allowed driver display of the entirety of each wheel and its contact with the ground. (See, e.g., side views 410 and 420 of FIG. 4.) A third camera (270) is placed on the front of the vehicle 200 as shown for the frontal view. (See, front view 430 of FIG. 4.) A fourth camera (280) is placed on the rear of the vehicle for the rear view. (See, rear view 440 of FIG. 4.) As separately shown in FIG. 1, the respective camera outputs 110 are then sent to a configurable quad video processor 120 for display to the driver. (See, e.g., the display 160 of FIG. 1 and an exemplary display 400 of FIG. 4.) The monitor as shown is a touch-screen display 160, with a touch screen 161 which when touched can switch between a full-screen view 300 of a chosen camera, and a return to a quad display mode. (See, e.g., quad display layout of 310, 320, 330 and 340 of FIG. 3.)

Included with the CU 100 can be a digital video recorder 150 that may be flash-memory based. The digital video recorder 150 can be configured to provide a record of video events for later review. With two 32 GB cards installed, full-sized, full-frame rate video can be collected for up to 16 hours, e.g., on internal battery power. Audio recording from an on-board microphone or line-in inputs can also be configured for optional audio recording features. The system can also be externally powered, e.g., via a cigarette lighter adapter or other conventional DC power connection(s).

Returning now to the exemplary methods of driver's vision augmentation, the video cameras (e.g., 250, 260, 270, 280) can be chosen for operation in any portion of the electromagnetic spectrum. Such video cameras can be configured around the exterior of a vehicle 200 to provide real-time imagery of ground contact, e.g., of all tires (210, 220, 230, 240). See, FIG. 3 for an exemplary quad display layout, and FIG. 4 for exemplary quad displays. Video imagery based on such externally mounted video cameras can be used to avoid hazards, e.g., during an off-road terrain negotiation. (See, e.g., an exemplary edge of road or a cliff 421, a front view horizon 431, and a rear view horizon 440 variously depicted in FIG. 4.) Such a video can be displayed on a touch-screen monitor 161 for display 160, e.g., to the driver. The monitor (e.g., a touch-screen display 160) can switch to full screen view 300 of any camera input, e.g., when a respective segment (310, 320, 330, 340) of the touch screen 300 is touched. Touching the monitor again, e.g., anywhere on the touch-screen display 300, can switch the display back to a quad screen display. (See, e.g., views 410, 420, 430, 440 of FIG. 4.)

To give the vehicle driver a view, e.g., of wheel contact with the ground at all times, video cameras (e.g., 250 and 260) can be placed behind the respective rear wheel (e.g., 210 and/or 220) looking forward, along with a front view camera 270 and a rear view camera 280. Video inputs from these cameras can then be input 110 for display 160 to the driver in a quad view (e.g., 310, 320, 330, 340) arranged to represent the vehicle situation awareness. The touch screen itself can be used to switch display views. For example, the driver touching one of the quadrants (e.g., 310, 320, 330 or 340) may effect a control 140 for the video quad 120 to switch the display output to a “full-screen” view of that camera. When touched again, it reverts to a normal quad mode.

The video cameras (e.g., 250, 260, 270, 280) can be chosen to operate in any portion of the electromagnetic spectrum in order to meet mission requirements. The system can have a control unit 100 powered by a power source 130, e.g., BA-5590 (12 VDC) battery. A programmable video quad unit 120 inside the control unit 100 receives the video inputs 110 from the cameras and sends the appropriate video display (e.g., quad or full-screen) to the driver's monitor 160. A digital video recorder 150 using compact flash media can be installed should video recording be desired.

The video cameras (e.g., 250, 260, 270, 280) can be placed behind the rear wheels, e.g., with the use of extension brackets (e.g., 251 and 261) that are attached to the vehicle based on fasteners, e.g., 3M “Dual Lock” reclosable fasteners. Should a camera or the associated extension bracket come in contact with a fixed ground object, such quick disconnect connectors can release the cameras in order to protect the installed cable.

As implemented, the M-DVAS can be very simple to install and to operate. Being self-contained and capable of being self-powered, the M-DVAS can be installed in virtually any vehicle in a very short time. In darkness, Cadmium Sulfide (CdS) sensors associated with low intensity IR illuminated cameras can automatically activate LED illumination, which LED illumination was found to be effective up to approximately 45 feet, thereby providing adequate illumination to drive under the cover of darkness with “lights out”. Under such extreme conditions the M-DVAS demonstrated its effectiveness, including the ability to switch the video sources (250, 260, 270, 280) to and from the full-screen mode simply by touching the touch screen 161 of the display 160.

It is obvious that many modifications and variations of the present invention are possible in light of the above teachings. It is therefore to be understood that within the scope of the appended claims, the invention may be practiced otherwise than as described.

What is claimed is:

1. A vision augmentation system for installation on a vehicle to provide video aids to assist vehicle drivers, comprising:
a plurality of cameras providing video inputs;
a quad video processor powered by a power source, wherein the quad video processor receives the video inputs from the cameras and outputs an appropriate video display; and
a touch screen display to receive the output from the quad video processor and display said appropriate video display, the touch screen display being separately connected to a converter unit for touch screen connection back to the quad video processor for touch-screen control of said appropriate video display.

2. The vision augmentation system recited in claim 1, wherein the power source can be either an internal battery or an externally connected power source.

3. The vision augmentation system recited in claim 1, further comprising a digital video recorder, wherein the quad video processor is connected to the digital video recorder and the touch screen display.

4. The vision augmentation system recited in claim 1, wherein the cameras are mounted around a periphery of the vehicle to allow its driver to see the immediate area around each tire of the vehicle to enhance the vehicular off-road mobility, safety and situation awareness.

5. The vision augmentation system recited in claim 1, wherein four video cameras are deployed around the vehicle having front and rear wheels, two of the cameras being mounted on a respective bracket behind a respective rear wheel looking forward; a third camera being placed on a front of the vehicle for a frontal view; and a fourth camera being placed on a rear of the vehicle for a rear view.

6. The vision augmentation system recited in claim 1, wherein touching a segmented area of the touch screen can switch between a full-screen view of a chosen camera and a return to a quad display mode.

7. The vision augmentation system recited in claim 1, further comprising a flash-memory based digital video recorder configured to provide an audio and/or video record of video events for later review.

8. A vision augmentation method to provide video aids to assist a vehicle driver, comprising:
choosing video cameras for operation in a select portion of the electromagnetic spectrum;
configuring said video cameras around an exterior of a vehicle to provide video inputs of respective real-time imagery, including video inputs of ground tire contacts;
providing a touch screen display capable of displaying said real time imagery in a quadrant display layout;
providing a control unit powered by a power source, wherein a programmable video quad unit inside the control unit receives the video inputs from the cameras and sends the appropriate video display to the touch screen display; and
providing a control capability to switch between a full screen view of any selected camera input and a quad screen display with the use of the touch screen display.

9. The vision augmentation method recited in claim 8, wherein a number of cameras are placed to the rear of the vehicle to look forward, a camera is provided for a front view and a camera is provided for a rear view, wherein videos from these cameras are input for display to the driver in a quad view arranged to represent vehicle situation awareness.

10. The vision augmentation method recited in claim 8, wherein if the driver touches one of the quadrants of the display, the touch screen display switches to a full-screen view of the quadrant image, and when touched again, the touch screen display reverts to a normal quad mode.

11. The vision augmentation method recited in claim 8, wherein a digital video recorder using compact flash media can be installed should video recording be desired.

12. The vision augmentation method recited in claim 8, wherein video cameras are placed behind rear wheels with the use of extension brackets that are attached to the vehicle based on fasteners.

13. The vision augmentation method recited in claim 8, wherein during hours of darkness, Cadmium Sulfide sensors associated with low intensity IR illuminated cameras automatically activate LED illumination to provide adequate illumination to drive under the cover of darkness.

14. The vision augmentation method recited in claim 8, wherein any one of the video sources can be switched to and from the full-screen mode with the use of the touch screen of the display.
